(19) United States
(12) Patent Application Publication
(10) Pub. No.: US 2026/0194947 A1
(43) Pub. Date: Jul. 9, 2026

(54) POWER MANAGEMENT METHOD AND ELECTRONIC DEVICE

(71) Applicant: Wistron Corporation, New Taipei City (TW)

(72) Inventor: Peijung Peng, New Taipei City (TW)

(73) Assignee: Wistron Corporation, New Taipei City (TW)

(21) Appl. No.: 19/045,557

(22) Filed: Feb. 5, 2025

(30) Foreign Application Priority Data
Jan. 3, 2025 (TW) 114100210

(51) Int. Cl. G06F 1/26

(52) U.S. Cl. CPC G06F 1/26

(57) ABSTRACT

This disclosure presents a power management method and an electronic device. The method includes: obtaining log data related to the electronic device, where the log data includes values of components within the electronic device and usage behavior data of the electronic device; generating processor predicted performance according to the log data; and inputting the log data, the predicted processor performance, and a prompt into a language model to obtain a power setting related to the electronic device.

### CROSS-REFERENCE TO RELATED APPLICATION

This application claims the priority benefit of TW application serial no. 114100210, filed on Jan. 3, 2025. The entirety of the above-mentioned patent application is hereby incorporated by reference herein and made a part of this specification.

### BACKGROUND

### Technical Field

The disclosure relates to a power management method suitable for various scenarios and an electronic device using the method thereof.

### Description of Related Art

The design of modern laptops is no longer confined solely to hardware performance improvements. User requirements for laptops are no longer limited to high performance and portability, but rather emphasize the ability of the laptop to adapt to various usage scenarios and enhance operational convenience.

Currently, the usage scenarios of laptops include, but are not limited to, professional activities, recreational pursuits, educational endeavors, and creative undertakings. In response to these diverse requirements, laptops need to be equipped with a more comprehensive management system. However, existing technologies still have many shortcomings in laptop management. For example, in terms of heat dissipation and power management, current technologies are mostly based on fixed-rule hardware control methods and lack targeted and real-time adjustment capabilities. Typical management methods are based on static condition settings, such as laptops activating a fan when the temperature reaches a certain threshold, or automatically switching to a low-performance mode when battery power drops to a certain level. Therefore, there are still many technical challenges in power management systems of laptops.

### SUMMARY

A power management method suitable for an electronic device is provided in the disclosure. The power management method includes the following operation. First log data related to the electronic device is obtained, in which the first log data includes values of components within the electronic device and usage behavior data of the electronic device. Predicted processor performance is generated according to the first log data. The first log data, the predicted processor performance, and a first prompt are input into a language model to obtain a power setting related to the electronic device.

From another perspective, an electronic device including a memory and a processor is provided in an embodiment of the disclosure. The memory is configured to store multiple commands. The processor is electrically connected to the memory and is configured to execute these commands to complete the above power management method.

In order to make the above-mentioned features and advantages of the disclosure comprehensible, embodiments accompanied with drawings are described in detail below.

### BRIEF DESCRIPTION OF THE DRAWINGS

FIG. 1 is a block diagram of an electronic device according to an embodiment.

FIG. 2 is a flowchart of a power management method according to an embodiment.

FIG. 3 is a schematic diagram illustrating the operation between the machine learning model and the language model according to an embodiment.

FIG. 4 is a schematic diagram illustrating continuous improvement based on feedback according to an embodiment.

### DETAILED DESCRIPTION OF DISCLOSED EMBODIMENTS

A portion of the embodiments of the disclosure will be described in detail with reference to the accompanying drawings. Element symbol referenced in the following description will be regarded as the same or similar element when the same element symbol appears in different drawings. These examples are only a portion of the disclosure and do not disclose all possible embodiments of the disclosure. More precisely, these embodiments are only examples of the system and method within the scope of the patent application of the disclosure.

The terms “first”, “second”, etc. used in this document do not specifically refer to the sequence or order, but are only used to distinguish components or operations described with the same technical terms.

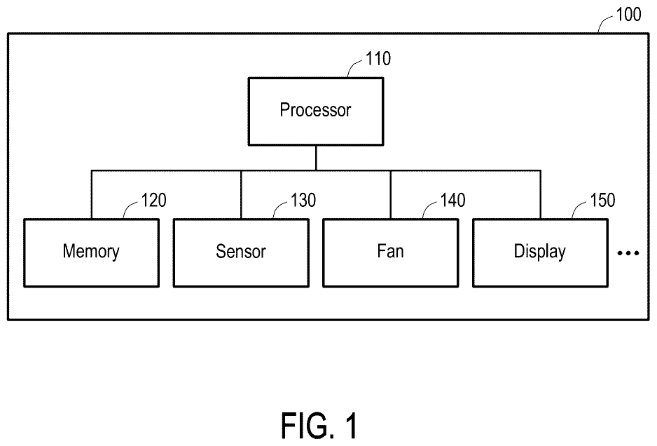

FIG. 1 is a block diagram of an electronic device according to an embodiment. Referring to FIG. 1, in this embodiment, the electronic device 100 is a laptop. However, in other embodiments, the electronic device 100 may also be a personal computer, a tablet, a smartphone, a server, a home appliance, or other electronic devices. The electronic device 100 includes a processor 110, a memory 120, a sensor 130, a fan 140, a display 150, etc. The processor 110 is electrically connected to the memory 120, the sensor 130, the fan 140, and the display 150. For the sake of simplicity, not all components of the electronic device 100 are shown here.

The processor 110 may be a central processing unit, a graphics processing unit, a microprocessor, a microcontroller, a deep-learning processing unit (DPU), a neural network processing unit (NPU), a tensor processing unit (TPU), an application specific integrated circuit (ASIC), a programmable logic device (PLD), etc. Alternatively, in some embodiments, the electronic device 100 may also be equipped with multiple processors such as a central processing unit, a graphics processing unit, and a neural network processing unit. The memory 120 may be a random access memory, a read-only memory, a flash memory, a floppy disk, a hard disk, an optical disk, a USB flash drive or a magnetic tape, in which a multiple commands are stored. The sensor 130 is, for example, a temperature sensor. The display 150 may include a liquid crystal display panel or an organic light emitting diode panel.

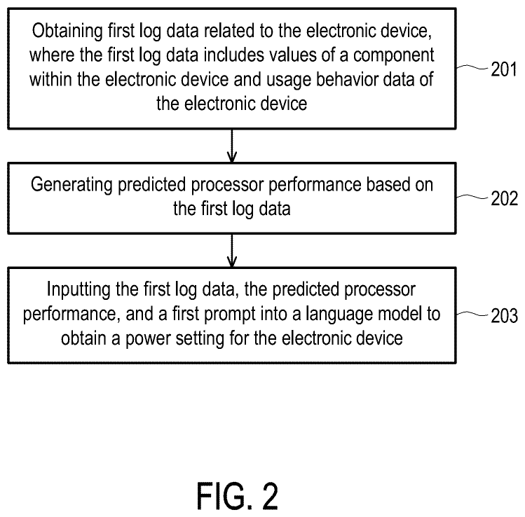

The processor 110 executes commands in the memory 120 to complete a power management method. FIG. 2 is a flowchart of a power management method according to an embodiment. Referring to FIG. 2, in step 201, first log data related to the electronic device is obtained. The first log data includes values of one or more components within the electronic device 100 and usage behavior data of the electronic device. For example, the components may be a sensor 130, a fan 140, a processor 110, a display 150, a battery (not shown), a thermocouple, etc. The values of the component may be processor usage rate, processor frequency, processor power, processor voltage, temperature, battery status, hard disk voltage, error code, etc. The error code is generated when the processor 110 encounters an exception or a crash during the execution of a program. The error code may indicate information such as the program that caused the error, the time, the input at the moment, etc. In addition, the above-mentioned temperature may be the temperature of the central processing unit, the temperature of the battery, the temperature of the housing, the temperature of the graphics processing unit, etc. The battery status includes the current battery capacity, the maximum capacity of the battery, etc. On the other hand, user behavior includes opening logs of an application. This application may be a game, a browser, a productivity tool, etc., and the disclosure is not limited thereto. The opening log includes information such as when the application was opened and how long it was opened. In other embodiments, the log data may include any logs of various software such as operating systems and drivers.

In step 202, a predicted processor performance is generated based on the first log data. In some embodiments, the processor performance at a future time point (e.g., 30 minutes later) may be predicted based on the log data that has occurred in the past. In some embodiments, the processor performance may also be predicted for a future period of time (e.g., the next 30-40 minutes), this disclosure is not limited thereto. In other words, the predicted processor performance may be expressed as a single value or a vector (including the predicted processor performance at multiple time points). Step 202 may adopt any machine learning model to make predictions. This machine learning model is, for example, decision tree, random forest, k-nearest neighbors algorithm, multilayer neural network, convolutional neural network, support vector machine, extreme gradient boosting (XGBoost), etc. The architecture of the convolutional neural network may adopt LeNet, AlexNet, VGG, GoogLeNet, ResNet, DenseNet or YOLO (You Only Look Once), etc. The generated predicted processor performance is expressed, for example, as a percentage, which also represents the subsequent power demand. For example, if a user customarily opens the browser at a specific time in the evening to start watching videos, followed by running a game, it is possible to predict in advance an increased demand for processor performance upon opening the browser, which also means that the subsequent power demand will be greater. Alternatively, in the event that a user customarily initiates a certain communication software at a later time, and subsequently, after a period of time, sets the electronic device 100 to enter sleep mode and commence charging, in such a context, it may be predicted that upon initiating a communication software, there may subsequently be a reduction in processor performance.

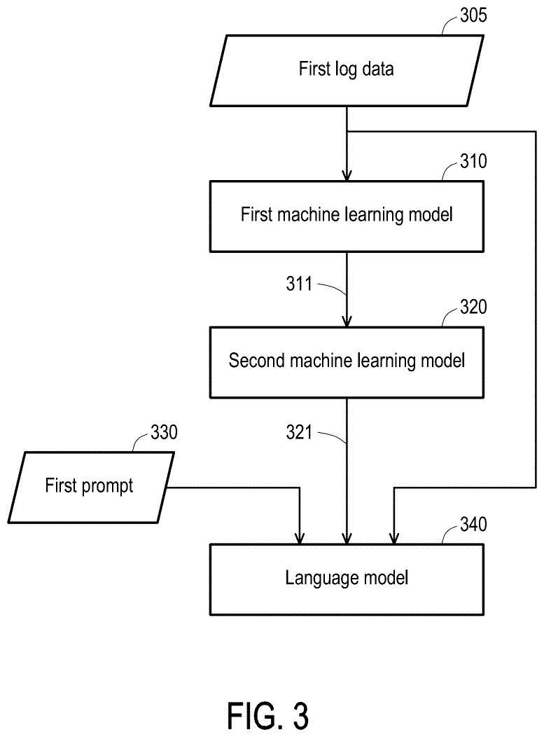

FIG. 3 is a schematic diagram illustrating the operation between the machine learning model and the language model according to an embodiment. In the embodiment of FIG. 3, two machine learning models 310 and 320 are used to generate the predicted processor performance 321. Specifically, the first log data 305 is input into the first machine learning model 310 to obtain the predicted processor frequency 311. The predicted processor frequency 311 may be the processor frequency at a certain time point in the future or within a period of time. Then, the processor frequency 311 is input into the second machine learning model to obtain the predicted processor performance 321. The first machine learning model 310 is different from the second machine learning model 320. For example, the first machine learning model 310 is a random forest and the second machine learning model 320 is extreme gradient boosting. In some experiments, it was found that predicting processor frequency first and then predicting processor performance may lead to better accuracy.

Referring to FIG. 2 and FIG. 3, in step 203, the first log data 305, the predicted processor performance 321, and the first prompt 330 are input into the language model 340 to obtain a power setting for the electronic device 100. The language model 340 is, for example, a GPT series, a BERT series, TAIDE (trustworthy AI dialog engine), etc., and the disclosure is not limited thereto. In some implementations, the first prompt 330 is configured to instruct an artificial intelligence (AI) agent to perform power management. For example, the first prompt 330 may include: “Please act as an AI agent and perform power management according to the logs provided by me and the predicted processor performance for a future period of time, and provide the power settings”. In some embodiments, the power settings may include processor frequency, screen brightness, background program, or setting of update program. When the processor frequency increases, the screen brightness increases, and background programs are added, power consumption increases. On the other hand, since the first log data 305 includes an error code, this may be because a certain software or firmware has not been updated. Therefore, the power settings may also include setting of the update program (e.g., scheduling of updates, asking users consent for updates, etc.). In some embodiments, the first prompt 330 may explicitly instruct the AI agent to adjust the processor frequency, screen brightness, settings of background program settings, or settings of update program. In other embodiments, the above power settings may also be performed according to the response of the AI agent. For example, the AI agent could suggest reducing power consumption. Based on such suggestion, the processor frequency may be lowered, screen brightness may be decreased, or unnecessary background programs may be terminated.

In some embodiments, the output of the language model 340 is text, so keywords (e.g., increase power consumption or reduce power consumption) may be obtained from the text to perform related power settings. In other embodiments, a function call of the language model 340 may be used to call a specific function or program through the language model 340 to perform power settings.

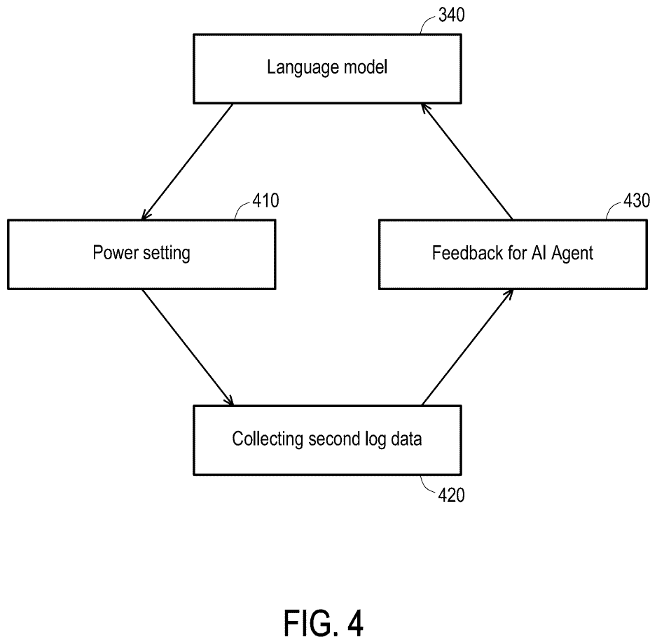

Through the methods of FIG. 2 and FIG. 3, the behavior of the user and various data on the electronic device 100 may be collected, and then the power settings may be adaptively adjusted to improve user satisfaction. In some embodiments, log data may be continuously collected as feedback for the AI agent. FIG. 4 is a schematic diagram illustrating continuous improvement based on feedback according to an embodiment. Referring to FIG. 4, after the language model 340 provides the power setting 410, the electronic device 100 is adjusted according to the power setting 410 (e.g., adjusting the processor frequency, etc.), and then in step 420, the log data (referred to as the second log data) of the electronic device 100 is continuously collected. Next, in step 430, these second log data serve as feedback for the AI agent. Specifically, the second log data and a second prompt may be input into the language model 340, and the second prompt is configured to instruct the AI agent to use the second log data as feedback to modify the strategy of the power management. For example, the second prompt includes: “Please analyze user behavior according to these log data and adjust the strategy of the power management”. For example, if the AI agent reduces the processor frequency, but then the user performs high-load tasks, this indicates that the strategy is wrong, and the strategy of the power management may be adjusted according to the newly collected log data.

In the above-mentioned electronic device and power management method, the next usage scenario may be predicted according to the behavior of the user and various data on the electronic device to adjust the corresponding power settings. In addition, as the usage of the user continues, the subsequent log data may also be provided as feedback to the AI agent for adjustment. In this way, the electronic device may provide better power usage rate and operating experience in various usage scenarios.

From another perspective, the disclosure also proposes a non-transitory computer-readable storage medium, such as a random access memory, a read-only memory, a flash memory, a floppy disk, a hard disk, an optical disk, a USB flash drive or a magnetic tape, network accessible databases, etc. Multiple instructions are stored in this storage medium. The storage medium stores multiple commands, and when the commands are executed by the computer system, the above-mentioned power management method may be completed.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A power management method, suitable for an electronic device, the power management method comprising:
obtaining first log data related to the electronic device, wherein the first log data comprises values of a component within the electronic device and usage behavior data of the electronic device;
generating a predicted processor performance according to the first log data; and
inputting the first log data, the predicted processor performance, and a first prompt into a language model to obtain a power setting related to the electronic device.

2. The power management method according to claim 1, wherein the first log data comprises a processor usage rate, a temperature, a battery status, or an error code, the usage behavior data comprises an opening log of an application, and the power setting comprises a processor frequency, a screen brightness, a background program, or setting of an update program.

3. The power management method according to claim 1, wherein generating the predicted processor performance according to the first log data comprises:
inputting the first log data into a first machine learning model to obtain a predicted processor frequency; and
inputting the predicted processor frequency into a second machine learning model to obtain the predicted processor performance, wherein the first machine learning model is different from the second machine learning model.

4. The power management method according to claim 3, wherein the first machine learning model is a random forest, and the second machine learning model is extreme gradient boosting.

5. The power management method according to claim 1, further comprising:
obtaining a second log data of the electronic device after adjusting the electronic device according to the power setting; and
inputting the second log data and a second prompt into the language model.

6. The power management method according to claim 5, wherein the first prompt is configured to instruct an artificial intelligence agent to perform power management, the second prompt is configured to instruct the artificial intelligence agent to use the second log data as feedback to modify a strategy of the power management.

7. The power management method according to claim 5, further comprising:
executing the power setting using a function call of the language model.

8. An electronic device, comprising:
a memory, configured to store a plurality of commands; and
a processor, electrically connected to the memory and configured to execute the commands to complete a plurality of steps:
obtaining first log data related to the electronic device, wherein the first log data comprises values of a component within the electronic device and usage behavior data of the electronic device;
generating a predicted processor performance according to the first log data; and
inputting the first log data, the predicted processor performance, and a first prompt into a language model to obtain a power setting related to the electronic device.

9. The electronic device according to claim 8, wherein the first log data comprises a processor usage rate, a temperature, a battery status, or an error code, the usage behavior data comprises an opening log of an application, and the power setting comprises a processor frequency, a screen brightness, a background program, or setting of an update program.

10. The electronic device according to claim 8, wherein generating the predicted processor performance according to the first log data comprises:
inputting the first log data into a first machine learning model to obtain a predicted processor frequency; and
inputting the predicted processor frequency into a second machine learning model to obtain the predicted processor performance, wherein the first machine learning model is different from the second machine learning model.

11. The electronic device according to claim 10, wherein the first machine learning model is a random forest, and the second machine learning model is extreme gradient boosting.

12. The electronic device according to claim 8, wherein the steps further comprises:
obtaining a second log data of the electronic device after adjusting the electronic device according to the power setting; and
inputting the second log data and a second prompt into the language model.

13. The electronic device according to claim 12, wherein the first prompt is configured to instruct an artificial intelligence agent to perform power management, the second prompt is configured to instruct the artificial intelligence agent to use the second log data as feedback to modify a strategy of the power management.

14. The electronic device according to claim 13, wherein the steps further comprises:
executing the power setting using a function call of the language model.

15. A non-transitory computer-readable storage medium, storing a plurality of commands, wherein the commands are executed by a computer system to complete a plurality of steps:
obtaining first log data related to the electronic device, wherein the first log data comprises values of a component within the electronic device and usage behavior data of the electronic device;
generating a predicted processor performance according to the first log data; and
inputting the first log data, the predicted processor performance, and a first prompt into a language model to obtain a power setting related to the electronic device.

16. The on-transitory computer-readable storage medium according to claim 15, wherein the first log data comprises a processor usage rate, a temperature, a battery status, or an error code, the usage behavior data comprises an opening log of an application, and the power setting comprises a processor frequency, a screen brightness, a background program, or setting of an update program.

17. The on-transitory computer-readable storage medium according to claim 15, wherein generating the predicted processor performance according to the first log data comprises:
inputting the first log data into a first machine learning model to obtain a predicted processor frequency; and
inputting the predicted processor frequency into a second machine learning model to obtain the predicted processor performance, wherein the first machine learning model is different from the second machine learning model.

18. The on-transitory computer-readable storage medium according to claim 15, wherein the steps further comprises:
obtaining a second log data of the electronic device after adjusting the electronic device according to the power setting; and
inputting the second log data and a second prompt into the language model.

19. The on-transitory computer-readable storage medium according to claim 18, wherein the first prompt is configured to instruct an artificial intelligence agent to perform power management, the second prompt is configured to instruct the artificial intelligence agent to use the second log data as feedback to modify a strategy of the power management.

20. The on-transitory computer-readable storage medium according to claim 18, wherein the steps further comprises:
executing the power setting using a function call of the language model.
